(19) United States
(12) Patent Application Publication
(10) Pub. No.: US 2026/0319395 A1
(43) Pub. Date: Oct. 15, 2026

(54) IMAGE FORMING APPARATUS

(71) Applicant: SHARP KABUSHIKI KAISHA, Osaka (JP)

(72) Inventor: Itsuo MATSUKI, Osaka (JP)

(21) Appl. No.: 19/643,119

(22) Filed: Apr. 9, 2026

(30) Foreign Application Priority Data
Apr. 14, 2025 (JP) 2025-065981

(51) Int. Cl. G03G 15/04

(52) U.S. Cl. CPC G03G 15/04045

(57) ABSTRACT

An image forming apparatus comprises a photoreceptor; an exposure device that forms an electrostatic latent image on the photoreceptor by irradiating, with pulse light, a plurality of sections arrayed in a first direction and a second direction orthogonal to the first direction; and a controller that controls the exposure device, wherein the controller controls the exposure device to emit the pulse light so that in a first section and a second section arrayed along the second direction among the plurality of sections, positions of centers of the pulse light in the first direction are selected to coincide with or differ from each other.

### CROSS-REFERENCE TO RELATED APPLICATION

The present application claims priority from Japanese Application JP2025-065981, the content of which is hereby incorporated by reference into this application.

### BACKGROUND

### 1. Field

The present disclosure relates to an image forming apparatus.

### BACKGROUND ART

In an electrophotographic image forming apparatus, after charging a surface of a drum-shaped or belt-shaped photoreceptor, light is radiated from an exposure device onto the surface of the photoreceptor to write an electrostatic latent image based on image data, and the electrostatic latent image is developed with toner. Thereafter, the toner image on the surface of the photoreceptor is primarily transferred to an intermediate transfer body, and further the toner image is secondarily transferred from the intermediate transfer body to a transfer material such as a printing sheet. In this manner, image printing is performed.

For example, in the related art, there is an image forming apparatus in which laser light is radiated from an exposure device onto a photoreceptor drum to form an electrostatic latent image. In this image forming apparatus, laser light is physically radiated onto positions of actual latent image lines on the surface of the photoreceptor drum to form electrostatic latent images, and a part of the laser light radiated at two adjacent actual latent image lines is overlapped to also form an electrostatic latent image on a virtual latent image line between the two actual latent image lines. Accordingly, without changing the structure of the optical system of the exposure device, hardware performance, and the like, the image forming apparatus can form electrostatic latent images at a pseudo resolution that is twice the resolution achievable only by actual latent image lines.

### SUMMARY

However, depending on conditions of laser light radiated onto two adjacent actual latent image lines, there is a case where, even at a position at which an electrostatic latent image is not to be formed on a virtual latent image line, an amount of the overlapped laser light at that position exceeds a threshold value for forming an electrostatic latent image. As a result, an image is erroneously formed in an electrostatic latent image at a portion where no image exists in image data, and a different portion occurs between the image data and a printed image. Thus, there has been a problem that image reproducibility of the image forming apparatus is degraded.

The present disclosure has been made to solve the above-mentioned problem, and has an object to provide an image forming apparatus that suppresses formation of an unintended electrostatic latent image and improves image reproducibility.

An image forming apparatus according to an aspect of the present disclosure includes: a photoreceptor; an exposure device that forms an electrostatic latent image on the photoreceptor by irradiating, with pulse light, a plurality of sections arrayed in a first direction and a second direction orthogonal to the first direction; and a controller that controls the exposure device. The controller controls the exposure device to emit the pulse light so that in a first section and a second section arrayed along the second direction among the plurality of sections, positions of centers of the pulse light in the first direction are selected to coincide with or differ from each other.

### BRIEF DESCRIPTION OF THE DRAWINGS

FIG. 1 is a schematic cross-sectional view illustrating an image forming apparatus according to the present disclosure.

FIG. 2 is a block diagram illustrating a part of the image forming apparatus according to the present disclosure.

FIG. 3 is a schematic view illustrating a photoreceptor and an exposure device according to the present disclosure.

FIG. 4 is a schematic view illustrating an example of image data according to the present disclosure.

FIG. 5 is a schematic view illustrating a pulse light irradiation position corresponding to FIG. 4.

FIG. 6 is a schematic view illustrating a formation position of an electrostatic latent image corresponding to FIG. 5.

FIG. 7 is a diagram illustrating a light amount of pulse light in each section of the first column in FIG. 5.

FIG. 8 is a diagram illustrating a light amount of pulse light in each section of the second column in FIG. 5.

FIG. 9 is a diagram illustrating a light amount of pulse light in each section of the third column in FIG. 5.

FIG. 10 is a diagram illustrating a pulse width of pulse light in the first section of each of the first column and the third column in FIG. 5.

FIG. 11 is a diagram illustrating a light amount of pulse light in each section of the fourth column in FIG. 5.

FIG. 12 is a diagram illustrating a light amount of pulse light in each section of the fifth column in FIG. 5.

FIG. 13 is a diagram illustrating a light amount of pulse light in each section of the sixth column in FIG. 5.

FIG. 14 is a diagram illustrating a light amount of pulse light in each section of the seventh column in FIG. 5.

FIG. 15 is a diagram illustrating a light amount of pulse light in each section of the eighth column in FIG. 5.

FIG. 16 is a diagram illustrating a light amount of pulse light in the second column in FIG. 5 in a modification example.

FIG. 17 is a diagram illustrating a light amount of pulse light in the sixth column in FIG. 5 in a modification example.

FIG. 18 is a diagram illustrating a light amount of pulse light in the fourth column in FIG. 5 in a modification example.

FIG. 19 is a diagram illustrating a light amount of pulse light in the eighth column in FIG. 5 in a modification example.

### DESCRIPTION OF EMBODIMENTS

With reference to the drawings, an embodiment of the present disclosure is described below. In the drawings, the same or equivalent elements are denoted by the same reference signs, and redundant descriptions are omitted. Further, an embodiment described below does not unduly limit the content of the present disclosure described in the claims, and not all configurations described in the embodiment are necessarily essential as means for solving the present disclosure.

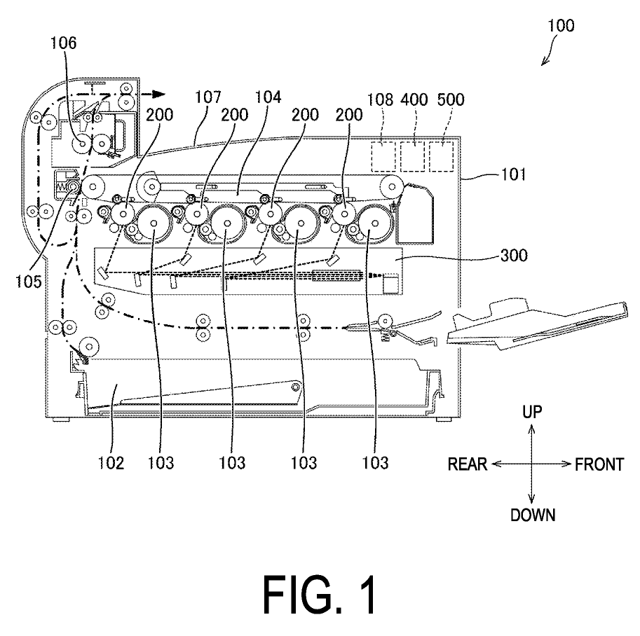

FIG. 1 is an external view of an image forming apparatus 100 according to the present disclosure. as illustrated in FIG. 1, the following description is given while defining an up-down direction and a front-rear direction of the image forming apparatus 100. However, those directions are directions defined for convenience of description, and do not limit directions when a user uses the image forming apparatus 100.

The image forming apparatus 100 is, for example, a printing machine capable of performing full-color printing, and forms a multicolor or single-color image on a printing sheet by an electrophotographic method. The image forming apparatus 100 according to the present disclosure is not limited to a printing machine, and may be, for example, a multifunction peripheral including a copy function, a printer function, a scanner function, a facsimile function, and the like. In the following description, the present disclosure exemplifies a case where the image forming apparatus 100 is a printing machine capable of performing full-color printing.

For example, the image forming apparatus 100 includes a housing 101 that accommodates respective components forming the image forming apparatus 100. A control unit 108 is provided inside the housing 101. The control unit 108 is a device that controls each component of the image forming apparatus 100. The control unit 108 is configured by a microcontroller and a peripheral circuit. The control unit 108 includes a processor and a memory. The processor executes a control program stored in the memory, and operates the microcontroller and the peripheral circuit as the control unit 108. All or part of processing executed by the microcontroller may be executed by a dedicated electronic circuit. The control unit 108 transmits various data such as image data, control signals, and the like to each component and each device included in the image forming apparatus 100, in accordance with an input operation by a user, data reception from outside, and the like, and causes the image forming apparatus 100 to execute various operations.

A controller 400 and an image processor 500 are provided inside the housing 101. The controller 400 is a device that controls an exposure device 300, which is described later. For example, the image processor 500 is a device that converts raster-format binary image data received from outside into a control signal, and transmits the control signal to the controller 400. Details of the controller 400 and the image processor 500 are described later.

Inside the housing 101, a feed tray 102, the photoreceptor 200, the exposure device 300, a development device 103, an intermediate transfer unit 104, a transfer roller 105, a fixing device 106, a sheet discharge tray 107, and the like are installed.

The photoreceptor 200 includes, for example, a cylindrical base body having conductivity and a photosensitive layer provided on an outer surface of the base body, and the photosensitive layer is charged to a predetermined potential. The photosensitive layer exhibits insulating properties in a normal state, and a region thereof irradiated with light exhibits conductivity. The photoreceptor 200 includes a rotation shaft extending along its axial line, and rotates about the rotation shaft by an electric motor, which is omitted in illustration.

The exposure device 300 radiates light for exposing a peripheral surface of the photosensitive layer of the photoreceptor 200. The exposure device 300 includes a semiconductor laser as a light source, is controlled by the controller 400 to radiate laser light for forming an image based on image data, and irradiates the peripheral surface of the photosensitive layer of the photoreceptor 200 with the laser light. By the laser light radiated from the exposure device 300, the charged peripheral surface of the photoreceptor 200 is exposed, and an electrostatic latent image corresponding to the image data is formed on the peripheral surface of the photosensitive layer of the photoreceptor 200.

The development device 103 supplies toner to the peripheral surface of the photosensitive layer of the photoreceptor 200, develops an electrostatic latent image, and thus forms a toner image. The present disclosure exemplifies the image forming apparatus 100 capable of printing a full-color image, and realizes full-color image printing by superposing single-color images corresponding to four colors of cyan, magenta, yellow, and black. In the present disclosure, four photoreceptors 200 and four development devices 103 correspond to yellow, magenta, cyan, and black. For example, the four photoreceptors 200 are structured similarly, and the four development devices 103 are structured similarly. Only the colors of toner supplied by the four development devices 103 are different. Although not exemplified in the present disclosure, an image forming apparatus that prints only a monochrome image may include only one photoreceptor and one development device corresponding to black. Further, the development device 103 includes an agitator that rotates to agitate the toner therein.

The intermediate transfer unit 104 is arranged above the photoreceptor 200. The intermediate transfer unit 104 is an integrated unit including an intermediate transfer belt arranged above the photoreceptor 200, an intermediate transfer roller that brings the intermediate transfer belt into contact with the photoreceptor 200, a belt driving roller and a tension roller that are in contact with an inner surface of the intermediate transfer belt and rotationally drive the intermediate transfer belt, and the like. By electric power supplied to the intermediate transfer roller, a transfer electric field is formed between the photoreceptor 200 and the intermediate transfer belt at a position of the intermediate transfer roller. By action of the transfer electric field, the toner image developed on the peripheral surface of the photoreceptor 200 is sequentially transferred onto the intermediate transfer belt. By sequentially transferring and superposing toner images corresponding to each of four colors of cyan, magenta, yellow, and black onto the intermediate transfer belt, a full-color toner image is formed on the intermediate transfer belt.

The transfer roller 105 is a member that transfers a toner image onto a printing sheet, and is, for example, rotatably provided at a position facing the belt driving roller with the intermediate transfer belt interposed therebetween and arranged so as to contact the intermediate transfer belt. The printing sheet fed from the feed tray 102 is conveyed by a plurality of rollers, and passes between the transfer roller 105 and the intermediate transfer belt. By electric power supplied to the belt driving roller, a transfer electric field is formed between the transfer roller 105 and the belt driving roller. By action of the transfer electric field, the toner image formed on the intermediate transfer belt is transferred onto one surface of the printing sheet.

The toner image transferred onto the printing sheet is heated and pressed by the fixing device 106 including a heating roller, a pressure roller, and the like, and is fixed onto the printing sheet. As described above, the image forming apparatus 100 completes printing of an image onto a printing sheet, based on the received image data. The printing sheet after printing is discharged onto the sheet discharge tray 107.

### Block Diagram of Image Forming Apparatus 100

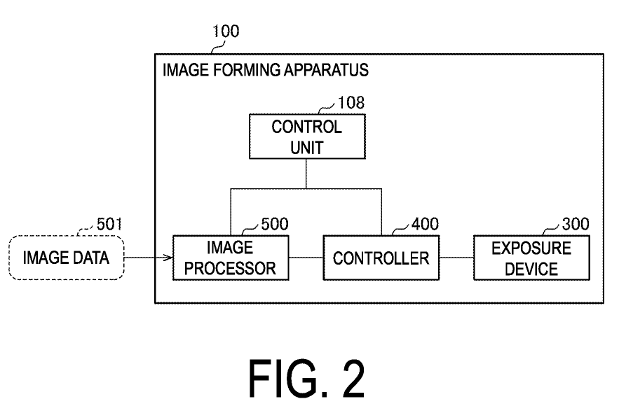

FIG. 2 is a block diagram illustrating a part of the image forming apparatus 100 according to the present disclosure. FIG. 2 illustrates the control unit 108, the exposure device 300, the controller 400, and the image processor 500, and illustrates a configuration of controlling an operation of the exposure device 300 among the respective components of the image forming apparatus 100.

The image processor 500 receives image data 501 from outside, converts the image data 501 into a control signal, and transmits the control signal to the controller 400. By the control signal transmitted from the image processor 500, the controller 400 controls radiation of laser light of the exposure device 300 for forming an electrostatic latent image based on the image data 501 on the photoreceptor 200. In the image forming apparatus 100 in FIG. 2, the control unit 108, the controller 400, and the image processor 500 are independent from each other, and the control unit 108 controls the controller 400 and the image processor 500. However, the control unit 108, the controller 400, and the image processor 500 may be configured by one processor, for example.

### Details of Structures of Photoreceptor and Exposure Device

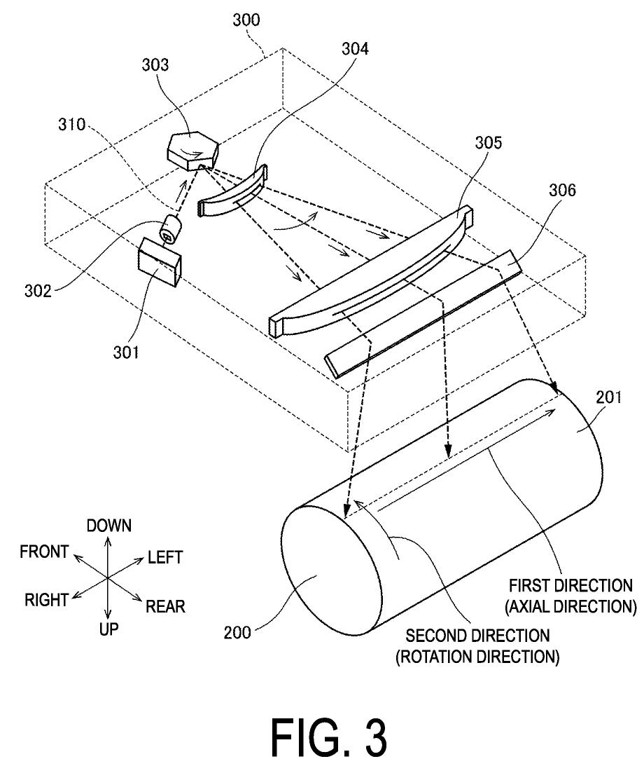

FIG. 3 is a schematic view illustrating the photoreceptor 200 and the exposure device 300 according to the present disclosure. FIG. 3 is a diagram illustrating a positional relationship between the exposure device 300 and the photoreceptor 200 inside the housing 101, as viewed upward from below the image forming apparatus 100 of FIG. 1. In FIG. 3, in addition to the up-down direction and the front-rear direction of the image forming apparatus 100 in FIG. 1, a left-right direction is defined. However, those directions are directions defined for convenience of description, and do not limit directions when a user uses the image forming apparatus 100. For example, an operation of the photoreceptor 200 is controlled by the control unit 108, and an operation of the exposure device 300 is controlled by the controller 400.

In FIG. 3, an outer shell of the exposure device 300 is indicated by a dotted line. The exposure device 300 includes a semiconductor laser 301, a collimator lens 302, a polygon mirror 303, a first fθ lens 304, a second fθ lens 305, a reflecting mirror 306, and the like. The semiconductor laser 301 is a light source of the exposure device 300, and is, for example, a pulse laser that outputs pulse light 310 at a constant repetition frequency. The pulse light 310 emitted from the semiconductor laser 301 passes through the collimator lens 302, the polygon mirror 303, the first fθ lens 304, the second fθ lens 305, and the reflecting mirror 306, as indicated by a dotted optical path in FIG. 3, and is focused onto the charged peripheral surface of the photoreceptor 200.

The collimator lens 302 collimates the pulse light 310 emitted as diffused light from the semiconductor laser 301. The pulse light 310 converted into parallel light is radiated to the polygon mirror 303.

The polygon mirror 303 is a rotating polygonal mirror that reflects the radiated pulse light 310 and rotates about a rotation axis along the up-down direction by an electric motor, which is omitted in illustration. For example, light corresponding to one pulse of the pulse light 310 is reflected by one mirror surface of the polygon mirror 303. As illustrated in FIG. 3, while the pulse light 310 is radiated to one mirror surface of the polygon mirror 303, the polygon mirror 303 rotates and the orientation of the mirror surface changes. In accordance with the change in the orientation of the mirror surface, a reflection direction of the pulse light 310 changes, and the pulse light 310 is scanned in the left-right direction. In FIG. 3, for example, an optical path of the pulse light 310 reflected by one mirror surface of the polygon mirror 303 moves from right to left in the left-right direction. The pulse light 310 reflected by the polygon mirror 303 enters the first fθ lens 304 and the second fθ lens 305.

The first fθ lens 304 and the second fθ lens 305 are lenses capable of changing a refractive index in accordance with an incident angle of the incident pulse light 310, and maintain a focal point of the pulse light 310 at a position of the peripheral surface of the photoreceptor 200 to scan the pulse light 310 even when the incident angle of the scanned pulse light 310 changes. The pulse light 310 scanned by the polygon mirror 303 is condensed in two stages by the first fθ lens 304 and the second fθ lens 305. Thereafter, an optical path is bent toward the peripheral surface of the photoreceptor 200 by the reflecting mirror 306, and the pulse light 310 is focused onto the peripheral surface of the photoreceptor 200.

As illustrated in FIG. 3, the photoreceptor 200 includes a cylindrical base body having conductivity and a photosensitive layer provided on an outer surface of the base body, and a surface of the photosensitive layer forms a peripheral surface 201 of the photoreceptor 200. The photoreceptor 200 rotates about a rotation shaft extending along the left-right direction by an electric motor, which is omitted in illustration. In the following description, an axial direction of the photoreceptor 200 may be referred to as a first direction, and a rotation direction of the photoreceptor 200 may be referred to as a second direction.

With rotation of the polygon mirror 303, the pulse light 310 is scanned along the first direction on the peripheral surface 201. In this manner, by reflection by one mirror surface of the polygon mirror 303, the pulse light 310 is radiated in a line from one end to the other end of the peripheral surface 201 in the first direction. In FIG. 3, for example, the one end of the peripheral surface 201 in the first direction is a right end of the peripheral surface 201, and the other end of the peripheral surface 201 in the first direction is a left end of the peripheral surface 201. Scanning of the pulse light 310 in the first direction is generally referred to as main scanning, and the first direction is also referred to as a main scanning direction.

When the optical path of the pulse light 310 reaches the other end of the peripheral surface 201 in the first direction, the pulse light 310 is reflected by the subsequent mirror surface of the polygon mirror 303, and the optical path of the pulse light 310 returns from the other end to the one end of the peripheral surface 201 in the first direction. At the same time, the control unit 108 rotates the photoreceptor 200 by a predetermined rotation angle. Accordingly, the peripheral surface 201 moves by a predetermined distance corresponding to the predetermined rotation angle in the second direction, and the pulse light 310 is radiated to an unirradiated region of the peripheral surface 201. As illustrated in FIG. 3, the peripheral surface 201 actually moves. However, when the peripheral surface 201 is regarded as a fixed surface, the pulse light 310 can be considered to be scanned along the peripheral surface 201 in the second direction. Scanning of the pulse light 310 in the second direction is generally referred to as sub-scanning, and the second direction is also referred to as a sub-scanning direction. The pulse light 310 advanced in the sub-scanning direction is scanned again along the first direction on the peripheral surface 201 by rotation of the polygon mirror 303.

The photosensitive layer provided on the peripheral surface 201 is insulating, and has electric charges charged to a predetermined potential. When the pulse light 310 is radiated to the peripheral surface 201, the photosensitive layer provided on the peripheral surface 201 exhibits conductivity in a region irradiated with the pulse light 310, and the electric charges charged in that region decrease. When a light amount of the pulse light 310 radiated to the peripheral surface 201 is equal to or more than a predetermined threshold value, the conductivity of the photosensitive layer in the region irradiated with the pulse light 310 increases, and the electric charges charged in that region disappear. When the toner is supplied from the development device 103 to the photoreceptor 200, the toner does not adhere to a region where electric charges remain, and the toner adheres to a region where electric charges disappear. Accordingly, a toner image is formed on the peripheral surface 201. The controller 400 adjusts the light amount of the pulse light 310, and thus a distribution of the electric charges on the peripheral surface 201 becomes a distribution based on the image data 501. With this, an electrostatic latent image from which a toner image corresponding to the image data 501 is to be formed is formed on the peripheral surface 201. As described above, by repeating the main scanning and the sub-scanning of the pulse light 310, an electrostatic latent image from which a toner image extending in the first direction and the second direction is to be formed can be formed on the peripheral surface 201. When the light amount of the pulse light 310 radiated to the peripheral surface 201 is insufficient, although an electrostatic latent image as a region in which electric charges decrease is formed in that region, electric charges remain without disappearing. Thus, adhesion of toner is incomplete, and a toner image corresponding to the image data 501 cannot be formed.

In FIG. 3, for simplicity, a configuration in which the exposure device 300 and one photoreceptor 200 are extracted is exemplified. However, the configuration of the exposure device 300 described above is also applicable to the image forming apparatus 100 including four photoreceptors 200 illustrated in FIG. 1. For example, although not illustrated, the exposure device 300 may have a configuration in which a light emission direction of the semiconductor laser 301, an angle of the polygon mirror 303 in the front-rear direction, and the like are changeable so that an optical path of the pulse light 310 can be arbitrarily switched toward the four photoreceptors 200, or a configuration in which a plurality of reflecting mirrors are additionally provided.

### Details of Formation Process of Electrostatic Latent Image

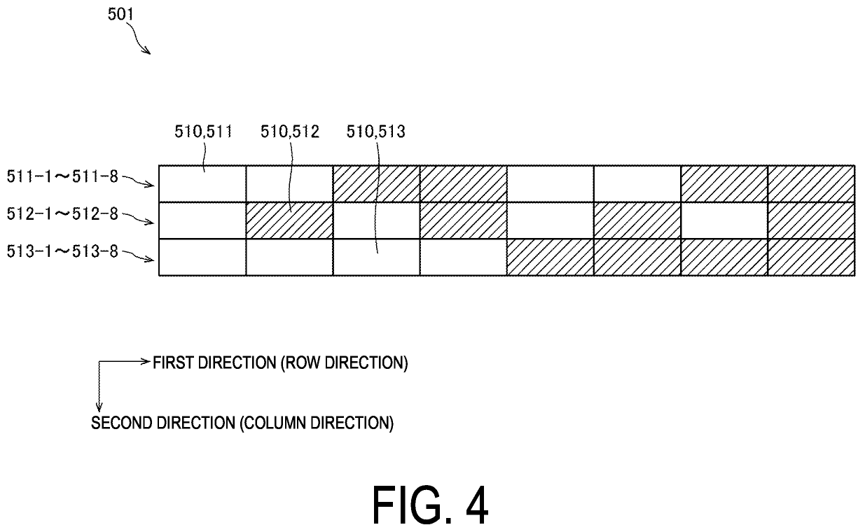

Hereinafter, with reference to FIG. 4 to FIG. 6, description is made on a process of forming an electrostatic latent image corresponding to the image data 501 on the peripheral surface 201 of the photoreceptor 200.

FIG. 4 is a schematic view illustrating an example of the image data 501 according to the present disclosure. The image data 501 includes a plurality of pixels 510 arrayed in a matrix. One pixel 510 is a square cell, and is a minimum unit forming the digital image data 501. By filling or not filling the pixel 510 with a predetermined color, an image such as a photograph can be expressed as the image data 501, which is an aggregate of the plurality of pixels 510. As described later in detail, a row direction in the image data 501 corresponds to the main scanning direction of the pulse light on the peripheral surface 201, and a column direction in the image data 501 corresponds to the sub-scanning direction of the pulse light on the peripheral surface 201. Therefore, to clarify those correspondences, the row direction in the image data 501 is referred to as the first direction, and the column direction in the image data 501 is referred to as the second direction. In FIG. 4, the pixel 510 filled with a predetermined color is hatched with diagonal lines, and the pixel 510 not filled is shown as a blank.

FIG. 4 illustrates, for simplicity, the image data 501 in which the plurality of pixels 510 are arranged in eight columns and three rows. In FIG. 4, the leftmost column is a first column, and the rightmost column is an eighth column. A first row, a second row, and a third row are arranged in order from top to bottom. In the image data 501, the pixels 510 included in the first row are referred to as first pixels 511, the pixels 510 included in the second row are referred to as second pixels 512, and the pixels 510 included in the third row are referred to as third pixels 513. Further, in the image data 501, the first pixels 511 in the first to eighth columns of the first row are referred to as first pixels 511-1 to 511-8, the second pixels 512 in the first to eighth columns of the second row are referred to as second pixels 512-1 to 512-8, and the third pixels 513 in the first to eighth columns of the third row are referred to as third pixels 513-1 to 513-8.

As illustrated in FIG. 4, in the image data 501, the first pixel 511-3, the first pixel 511-4, the first pixel 511-7, the first pixel 511-8, the second pixel 512-2, the second pixel 512-4, the second pixel 512-6, the second pixel 512-8, the third pixel 513-5, the third pixel 513-6, the third pixel 513-7, and the third pixel 513-8 are filled with the predetermined color, and the other pixels are not filled.

As illustrated in FIG. 2, the image processor 500 receives the image data 501 transmitted from outside. The image processor 500 generates a control signal for the controller 400 so that the controller 400 instructs the exposure device 300 on a position to be irradiated with the pulse light, based on the received image data 501.

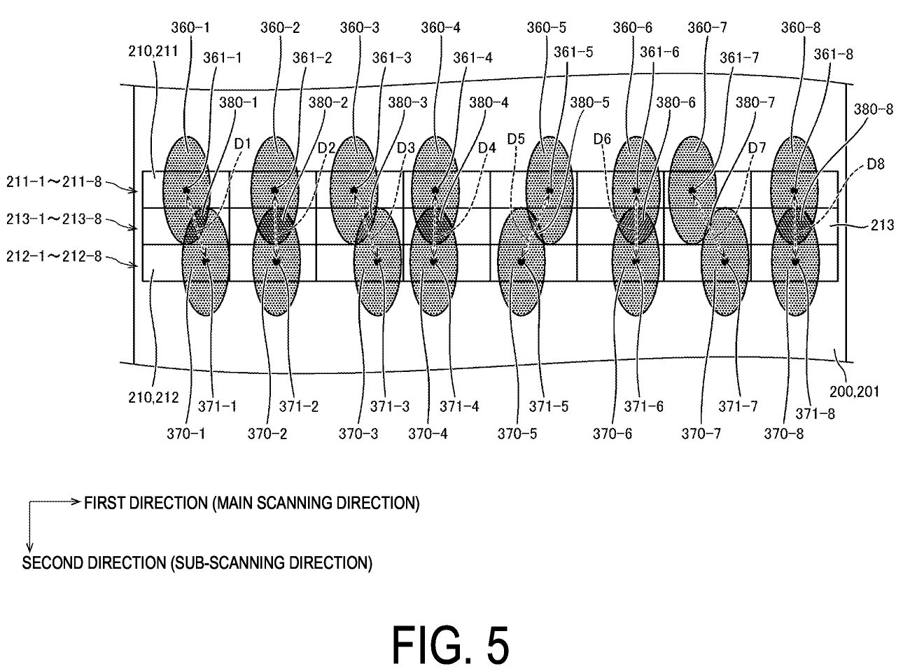

FIG. 5 is a schematic view illustrating a pulse light irradiation position corresponding to the image data 501 illustrated in FIG. 4. More specifically, FIG. 5 illustrates positions at which the exposure device 300 irradiates the peripheral surface 201 of the photoreceptor 200 with the pulse light so as to form, on the peripheral surface 201 of the photoreceptor 200, an electrostatic latent image from which a toner image corresponding to the raster-format binary image data 501 illustrated in FIG. 4 to be formed.

As illustrated in FIG. 5, a plurality of sections 210 corresponding to the plurality of pixels 510 of the image data 501 in FIG. 4 are set on the peripheral surface 201 as positions to which the pulse light is radiated. The plurality of sections 210 includes first sections 211 corresponding to the first pixel 511 of the image data 501 and second sections 212 corresponding to the third pixels 513 of the image data 501. Intermediate sections 213 are set between the first sections 211 and the second sections 212, and the intermediate sections 213 correspond to the second pixels 512 of the image data 501. Further, the first sections 211 that correspond to the first pixels 511-1 to 511-8 and are arrayed in the first direction are referred to as first sections 211-1 to 211-8, the intermediate section 213 that correspond to the second pixels 512-1 to 512-8 and are arrayed in the first direction are referred to as intermediate sections 213-1 to 213-8, and the second sections 212 that correspond to the third pixels 513-1 to 513-8 and are arrayed in the first direction are referred to as second sections 212-1 to 212-8. The first section 211, the intermediate section 213, and the second section 212 are arrayed along the second direction orthogonal to the first direction.

As illustrated in FIG. 5, positions to which first pulse lights 360-1 to 360-8 are radiated are set in the first sections 211-1 to 211-8, and positions to which second pulse lights 370-1 to 370-8 are radiated are set in the second sections 212-1 to 212-8. More specifically, positions of centers 361-1 to 361-8 of the first pulse lights 360-1 to 360-8 are set within the ranges of the first sections 211-1 to 211-8, and positions of centers 371-1 to 371-8 of the second pulse lights 370-1 to 370-8 are set within the ranges of the second sections 212-1 to 212-8. The first pulse lights 360-1 to 360-8 and the second pulse lights 370-1 to 370-8 have radiation regions that spread in a circular or elliptical shape, for example. Parts of the first pulse lights 360-1 to 360-8 and parts of the second pulse lights 370-1 to 370-8 are also radiated to the intermediate sections 213-1 to 213-8. Accordingly, overlap regions 380-1 to 380-8, which are regions where parts of the first pulse lights 360-1 to 360-8 and parts of the second pulse lights 370-1 to 370-8 overlap with each other, are generated in the intermediate sections 213-1 to 213-8.

As illustrated in FIG. 5, among the plurality of sections 210, in the first section 211 and the second section 212 that are arrayed in the second direction, the positions of the centers of the pulse lights in the first direction may coincide with or differ from each other. For example, in the first sections 211-1, 211-3, 211-5, and 211-7 and the second sections 212-1, 212-3, 212-5, and 212-7, the positions of the centers 361-1, 361-3, 361-5, and 361-7 of the first pulse lights 360-1, 360-3, 360-5, and 360-7 and the positions of the centers 371-1, 371-3, 371-5, and 371-7 of the second pulse lights 370-1, 370-3, 370-5, and 370-7 coincide with each other in the first direction. Further, in the first sections 211-2, 211-4, 211-6, and 211-8 and the second sections 212-2, 212-4, 212-6, and 212-8, the positions of the centers 361-2, 361-4, 361-6, and 361-8 of the first pulse lights 360-2, 360-4, 360-6, and 360-8 and the positions of the centers 371-2, 371-4, 371-6, and 371-8 of the second pulse lights 370-2, 370-4, 370-6, and 370-8 differ from each other in the first direction.

The image processor 500 converts, into a control signal, information relating to positions to which the pulse light is radiated on the peripheral surface 201 illustrated in FIG. 5, and transmits the control signal to the controller 400. Based on the received control signal, the controller 400 controls the exposure device 300 to emit the pulse light so that in the first section 211 and the second section 212 arrayed along the second direction among the plurality of sections 210, the positions of the centers of the pulse lights in the first direction are selected to coincide with or differ from each other.

More specifically, based on the control signal, the controller 400 controls the exposure device 300 so that the first sections 211-1 to 211-8 are irradiated sequentially with the first pulse lights 360-1 to 360-8. In this state, the pulse light irradiation position moves so as to perform scanning along the first direction from the first section 211-1 to the first section 211-8, and hence the first direction serves as the main scanning direction. For example, in FIG. 5, the controller 400 controls the exposure device 300 so that the semiconductor laser 301 emits the pulse light eight times at a predetermined time interval with respect to one mirror surface of the polygon mirror 303. Thereafter, the photoreceptor 200 rotates, and a subsequent mirror surface of the polygon mirror 303 that reflects the pulse light from the semiconductor laser 301 reflects the pulse light, so that the pulse light irradiation position moves to the second section 212-1. Then, based on the control signal, the controller 400 subsequently irradiates the second sections 212-1 to 212-8 with the second pulse lights 370-1 to 370-8. The controller 400 adjusts the emission timing of the pulse light from the semiconductor laser 301. With this, the positions of the centers 361-1 to 361-8 of the first pulse lights 360-1 to 360-8 and the positions of the centers 371-1 to 371-8 of the second pulse lights 370-1 to 370-8 in the first direction can be changed. For example, in a case where the first pulse light 360-1 is emitted at the predetermined time interval, when the center 361-1 is at the center of the first section 211-1 in the first direction, the center 361-3 of the first pulse light 360-3 in the first direction can be moved from the center of the first section 211-3 to the left by advancing the emission timing, and the center 361-5 of the first pulse light 360-5 in the first direction can be moved from the center of the first section 211-5 to the right by delaying the emission timing.

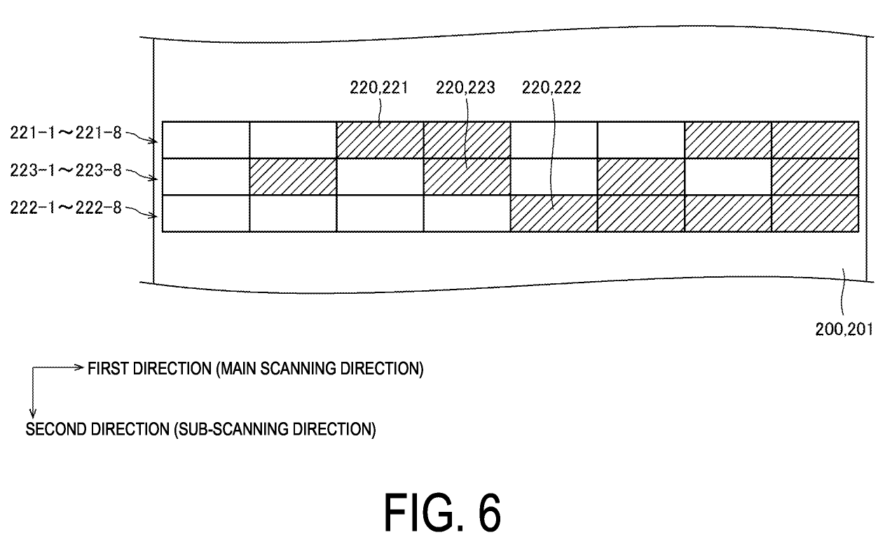

FIG. 6 is a schematic view illustrating a formation position of an electrostatic latent image 220 corresponding to FIG. 5. More specifically in FIG. 6, when the exposure device 300 irradiates the peripheral surface 201 with the pulse light as illustrated in FIG. 5, at a position where the light amount of the pulse light with which the peripheral surface 201 is irradiated exceeds the predetermined threshold value, the electrostatic latent image 220 is formed as illustrated in FIG. 6. In FIG. 6, a position at which where the electrostatic latent image 220 is formed is hatched with diagonal lines, and a position at which the light amount of the radiated pulse light is less than the predetermined threshold value, and the electrostatic latent image 220 from which a toner image corresponding to the image data 501 is to be formed is not formed is expressed as a blank. The electrostatic latent image 220 from which a toner image corresponding to the image data 501 formed at a position corresponding to the first section 211 is to be formed is referred to as a first latent image 221, and the electrostatic latent image 220 from which a toner image corresponding to the image data 501 formed at a position corresponding to the second section 212 is to be formed is referred to as a second latent image 222. Further, the electrostatic latent image 220 from which a toner image corresponding to the image data 501 formed at a position corresponding to the intermediate section 213 is to be formed is referred to as a virtual latent image 223. In other words, the electrostatic latent image 220 is an image obtained by arraying the first latent image 221, the virtual latent image 223, and the second latent image 222 in the second direction.

As illustrated in FIG. 6, the exposure device 300 can form the first latent images 221-1 to 221-8 on the peripheral surface 201 by the first pulse lights 360-1 to 360-8 with which the first sections 211-1 to 211-8 are irradiated, and can form the second latent images 222-1 to 222-8 on the peripheral surface 201 by the second pulse lights 370-1 to 370-8 with which the second sections 212-1 to 212-8 are irradiated. Further, the virtual latent images 223-1 to 223-8 can be formed in the intermediate sections 213-1 to 213-8 by the overlap regions 380-1 to 380-8 where parts of the first pulse lights 360-1 to 360-8 and parts of the second pulse lights 370-1 to 370-8 overlap with each other. For example, in FIG. 6, in the first latent images 221-3, 221-4, 221-7, and 221-8, the second latent images 222-5 to 222-8, and the virtual latent images 223-2, 223-4, 223-6, and 223-8, the electrostatic latent image 220 from which a toner image corresponding to the image data 501 is to be actually formed is formed. At the positions other than those, the electrostatic latent image 220 from which a toner image corresponding to the image data 501 is to be formed is not formed.

As understood from FIG. 4, FIG. 5, and FIG. 6, based on the image data 501 illustrated in FIG. 4, the image processor 500 generates a control signal in which the first pixel 511, the second pixel 512, and the third pixel 513, which are three consecutive pixels among the plurality of pixels 510, are associated with the first section 211, the intermediate section 213, and the second section 212 as illustrated in FIG. 5. Based on the control signal, as illustrated in FIG. 6, the controller 400 controls the exposure device 300 so that the first latent image 221, the virtual latent image 223, and the second latent image 222 corresponding to the first pixel 511, the second pixel 512, and the third pixel 513 are formed. Here, the first section 211 and the second section 212 are sections that are actually irradiated with the pulse light. Thus, in the second direction, the electrostatic latent images 220 from which toner images corresponding to the image data 501 corresponding to the three consecutive pixels, namely, the first pixel 511, the second pixel 512, and the third pixel 513 are to be formed can be formed by two irradiations with the pulse light. Accordingly, as compared to a case where all the electrostatic latent images 220 from which toner images corresponding to the image data 501 corresponding to the first pixel 511, the second pixel 512, and the third pixel 513 are to be formed are formed by the individual pulse light, the number of irradiation times with the pulse light can be reduced. For example, in the second direction, one virtual latent image line can be formed for one actual latent image line along the first direction. Therefore, when the image data 501 has a size of 1,200 px × 1,200 px, and the plurality of pixels 510 are arranged in 1,200 rows and 1,200 columns, the number of pulse light irradiations is 1,200 times in the first direction, which is the main scanning direction, and approximately 600 times in the second direction, which is the sub-scanning direction. Accordingly, even when the resolution in the sub-scanning direction that the optical system of the exposure device 300 can achieve in hardware is half of that of the image data 501, the electrostatic latent image 220 from which a toner image corresponding to the image data 501 is to be formed can be formed with the same resolution as the image data 501 without changing mechanical performance or the like.

As illustrated in FIG. 4, in the second pixels 512, the second pixels 512-1, 512-3, 512-5, and 512-7 are not filled, and the second pixels 512-2, 512-4, 512-6, and 512-8 are filled with the predetermined color. Accordingly, as illustrated in FIG. 6, the electrostatic latent image 220 from which a toner image corresponding to the image data 501 is to be formed is not formed for the virtual latent images 223-1, 223-3, 223-5, and 223-7 corresponding to the second pixels 512-1, 512-3, 512-5, and 512-7, and the electrostatic latent image 220 from which a toner image corresponding to the image data 501 is to be formed is formed for the virtual latent images 223-2, 223-4, 223-6, and 223-8 corresponding to the second pixels 512-2, 512-4, 512-6, and 512-8. In such a case, as illustrated in FIG. 5, in the first sections 211-1, 211-3, 211-5, and 211-7 and the second sections 212-1, 212-3, 212-5, and 212-7 that are located across the intermediate sections 213-1, 213-3, 213-5, and 213-7 corresponding to the virtual latent images 223-1, 223-3, 223-5, and 223-7 where the electrostatic latent image 220 from which a toner image corresponding to the image data 501 is to be formed is not formed, the positions of the centers 361-1, 361-3, 361-5, and 361-7 of the first pulse lights 360-1, 360-3, 360-5, and 360-7 and the positions of the centers 371-1, 371-3, 371-5, and 371-7 of the second pulse lights 370-1, 370-3, 370-5, and 370-7 differ from each other in the first direction. In contrast, as illustrated in FIG. 5, in the first sections 211-2, 211-4, 211-6, and 211-8 and the second sections 212-2, 212-4, 212-6, and 212-8 that are located across the intermediate sections 213-2, 213-4, 213-6, and 213-8 corresponding to the virtual latent images 223-2, 223-4, 223-6, and 223-8 where the electrostatic latent image 220 from which a toner image corresponding to the image data 501 is to be formed is formed, the positions of the centers 361-2, 361-4, 361-6, and 361-8 of the first pulse lights 360-2, 360-4, 360-6, and 360-8 and the positions of the centers 371-2, 371-4, 371-6, and 371-8 of the second pulse lights 370-2, 370-4, 370-6, and 370-8 coincide with each other in the first direction. Accordingly, as illustrated in FIG. 5, by setting distances D2, D4, D6, and D8 between the centers 361-2, 361-4, 361-6, and 361-8 and the centers 371-2, 371-4, 371-6, and 371-8 to minimum distances, the ranges and the light amounts in the overlap regions 380-2, 380-4, 380-6, and 380-8 for forming the virtual latent images 223-2, 223-4, 223-6, and 223-8 where the electrostatic latent image 220 from which a toner image corresponding to the image data 501 is to be formed is formed can be maximized. Thus, the electrostatic latent image 220 from which a toner image corresponding to the image data 501 is to be formed can be formed securely for the virtual latent images 223-2, 223-4, 223-6, and 223-8. Further, by increasing distances D1, D3, D5, and D7 between the centers 361-1, 361-3, 361-5, and 361-7 and the centers 371-1, 371-3, 371-5, and 371-7 from the minimum distances, the ranges and the light amounts in the overlap regions 380-1, 380-3, 380-5, and 380-7 for forming the virtual latent images 223-1, 223-3, 223-5, and 223-7 where the electrostatic latent image 220 from which a toner image corresponding to the image data 501 is to be formed is formed can be reduced. Thus, it is possible to prevent erroneous formation of the electrostatic latent image 220 from which a toner image corresponding to the image data 501 is to be formed for the virtual latent images 223-1, 223-3, 223-5, and 223-7.

The image processor 500 may generate the position information in which the positions of the centers 361-1 to 361-8 of the first pulse lights 360-1 to 360-8 and the positions of the centers 371-1 to 371-8 of the second pulse lights 370-1 to 370-8 are decided in the first direction, so that the first latent image 221, the virtual latent image 223, and the second latent image 222 are formed based on the image data 501. For example, in FIG. 5, the positions of the centers 361-1 to 361-8 of the first sections 211-1 to 211-8 and the positions of the centers 371-1 to 371-8 of the second sections 212-1 to 212-8 may be expressed by numerical coordinates in the first direction, and the numerical coordinates may be regarded as the position information. The image processor 500 may transmit the position information to the controller 400, and the controller 400 may control the pulse light irradiation position of the exposure device 300, based on the position information. Accordingly, the pulse light irradiation position of the exposure device 300 can be adjusted more finely based on the position information, and the electrostatic latent image 220 from which a toner image corresponding to the image data 501 is to be formed can be formed more accurately.

Further, the image processor 500 may generate the position information by deciding the positions of the centers 371-1 to 371-8 of the second pulse lights 370-1 to 370-8 in the first direction with reference to the positions of the centers 361-1 to 361-8 of the first pulse lights 360-1 to 360-8 in the first direction. For example, the positions of the centers 361-1 to 361-8 of the first sections 211-1 to 211-8 may be decided as numerical coordinates in the first direction, and the positions of the centers 371-1 to 371-8 of the second sections 212-1 to 212-8 may be decided with the numerical coordinates as references. For example, in FIG. 5, the positions of the centers 361-2, 361-4, 361-6, and 361-8 of the first sections 211-2, 211-4, 211-6, and 211-8 are decided as reference values of the numerical coordinates in the first direction. It is only required to set numerical coordinates in the first direction, which indicate the positions of the centers 371-2, 371-4, 371-6, and 371-8 of the second sections 212-2, 212-4, 212-6, and 212-8, to be equal to the reference values. Meanwhile, the positions of the centers 361-1, 361-3, 361-5, and 361-7 of the first sections 211-1, 211-3, 211-5, and 211-7 are decided as reference values of the numerical coordinates in the first direction. It is only required to set numerical coordinates in the first direction, which indicate the positions of the centers 371-1, 371-3, 371-5, and 371-7 of the second sections 212-1, 212-3, 212-5, and 212-7, to be different from the reference values.

With reference to the drawings, description is made below on the light amounts the first pulse lights 360-1 to 360-8 with which the first sections 211-1 to 211-8 are irradiated, those of the second pulse lights 370-1 to 370-8 with which the second sections 212-1 to 212-8 are irradiated, and those in the overlap regions 380-1 to 380-8 of the intermediate sections 213-1 to 213-8, which are illustrated in FIG. 5. In the following description, the matters that are common in the respective drawings are omitted as appropriate.

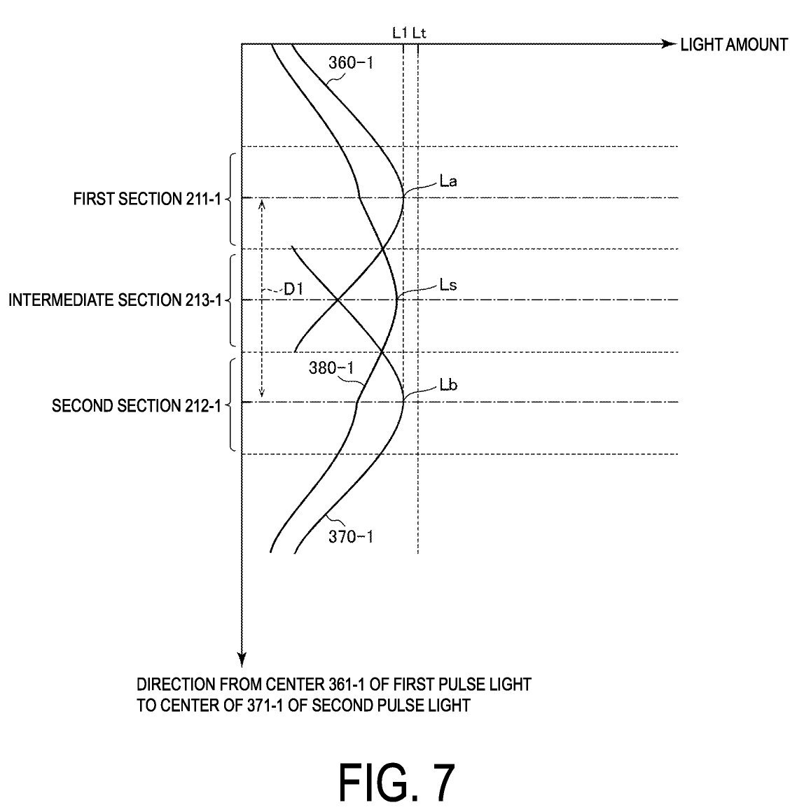

FIG. 7 is a diagram illustrating a light amount of the pulse light in the first section 211-1, the intermediate section 213-1, and the second section 212-1 of the first column in FIG. 5. The horizontal axis represents light amounts of the first pulse light 360-1 and the second pulse light 370-1, and a light amount in the overlap region 380-1. The vertical axis represents a position on the peripheral surface 201 in a virtual straight line along a direction from the center 361-1 to the center 371-1 in FIG. 5. The light amounts of the first pulse light 360-1 and the second pulse light 370-1 are maximized at the center 361-1 and the center 371-1, and the light amounts are reduced as being away from the center 361-1 and the center 371-1. The center 361-1 is located on the virtual center line of the first section 211-1 in the second direction, and the center 371-1 is located on the virtual center line of the second section 212-1 in the second direction. Further, the overlap region 380-1 is a region where a part of the first pulse light 360-1 and a part of the second pulse light 370-1 overlap with each other, the region being centered on the virtual center line of the intermediate section 213-1 in the second direction.

As illustrated in FIG. 7, as a predetermined light amount, a threshold value Lt is set. A region of the peripheral surface 201 of the photoreceptor 200, which is irradiated with the pulse light having a light amount equal to or more than the predetermined threshold value Lt, exhibits conductivity in the photosensitive layer on the peripheral surface 201, and the electrostatic latent image 220 from which a toner image corresponding to the image data 501 is to be formed is formed. As illustrated in FIG. 4, all of the first pixel 511-1, the second pixel 512-1, and the third pixel 513-1 corresponding to the first section 211-1, the intermediate section 213-1, and the second section 212-1 are not filled. Accordingly, as illustrated in FIG. 6, the electrostatic latent image 220 from which a toner image corresponding to the image data 501 is to be formed is not formed for the virtual latent image 223-1. Thus, as illustrated in FIG. 5, the controller 400 controls the exposure device 300 so that the position of the center 361-1 and the position of the center 371-1 differ from each other in the first direction.

In order to prevent formation of the electrostatic latent image 220 from which a toner image corresponding to the image data 501 is to be formed for both the first latent image 221-1 and the second latent image 222-1, both a light amount La of the first pulse light 360-1 at the center 361-1 and a light amount Lb of the second pulse light 370-1 at the center 371-1 are set to a first light amount L1 less than the threshold value Lt, as illustrated in FIG. 7. The position of the center 361-1 and the position of the center 371-1 differ from each other in the first direction. Thus, the distance D1 between the center 361-1 and the center 371-1 is a distance more than the minimum distance, and a range where a part of the first pulse light 360-1 and a part of the second pulse light 370-1 overlap with each other is reduced. Therefore, the maximum light amount Ls in the maximum light amount Ls in the overlap region 380-1 can be reduced to be kept below the threshold value Lt. Accordingly, formation of the electrostatic latent image 220 from which a toner image corresponding to the image data 501 is to be formed can be prevented for the virtual latent image 223-1.

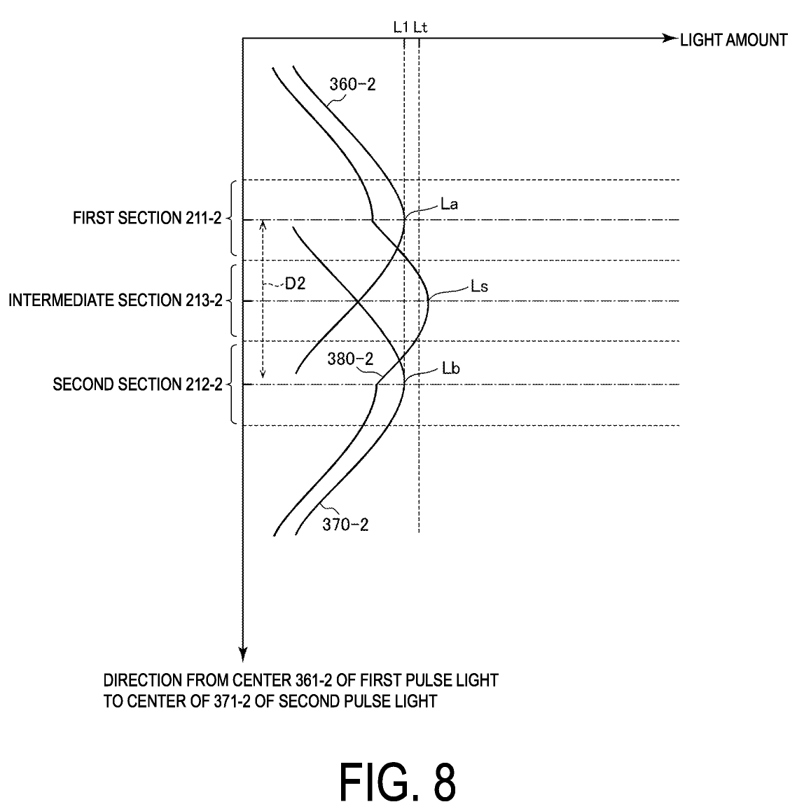

FIG. 8 is a diagram illustrating a light amount of the pulse light in the first section 211-2, the intermediate section 213-2, and the second section 212-2 of the second column in FIG. 5. The horizontal axis represents light amounts of the first pulse light 360-2 and the second pulse light 370-2, and a light amount in the overlap region 380-2. The vertical axis represents a position on the peripheral surface 201 in a virtual straight line along a direction from the center 361-2 to the center 371-2 in FIG. 5.

As illustrated in FIG. 4, the first pixel 511-1 corresponding to the first section 211-2 and the third pixel 513-2 corresponding to the second section 212-2 are not filled, and the second pixel 512-2 corresponding to the intermediate section 213-2 is filled. Accordingly, as illustrated in FIG. 6, the electrostatic latent image 220 from which a toner image corresponding to the image data 501 is to be formed is formed for the virtual latent image 223-2. Thus, as illustrated in FIG. 5, the controller 400 controls the exposure device 300 so that the position of the center 361-1 and the position of the center 371-1 coincide with each other in the first direction. Thus, the direction from the center 361-2 to the center 371-2 is the second direction, and the distance D2 between the center 361-2 and the center 371-2 is the minimum distance.

As illustrated in FIG. 8, in order to prevent formation of the electrostatic latent image 220 from which a toner image corresponding to the image data 501 is to be formed for either the first latent image 221-1 or the second latent image 222-1, both the light amount La of the first pulse light 360-1 at the center 361-1 and the light amount Lb of the second pulse light 370-1 at the center 371-1 are set to the first light amount L1 equal to or less than the threshold value Lt. The distance D2 is the minimum distance. Thus, a region where a part of the first pulse light 360-2 and a part of the second pulse light 370-2 overlap with each other is also maximized. Therefore, the maximum light amount Ls of the overlap region 380-2 can be equal to or more than the threshold value Lt, and the electrostatic latent image 220 from which a toner image corresponding to the image data 501 is to be formed can be formed for the virtual latent image 223-2.

FIG. 7 and FIG. 8 illustrate a configuration in which both the light amount La of the first pulse light 360-1 at the center 361-1 and the light amount Lb of the second pulse light 370-1 at the center 371-1 are set to the first light amount L1. However, the light amount La and the light amount Lb may not have the same intensity, and the light amounts may be changed as appropriate. In other words, when the virtual latent image 223 from which a toner image corresponding to the image data 501 is to be formed is not formed, the controller 400 is only required to adjust the light amounts La of the first pulse lights 360-1 to 360-8 at the centers 361-1 to 361-8 and the light amounts Lb of the second pulse lights 370-1 to 370-8 at the centers 371-1 to 371-8, which are emitted from the exposure device 300, so that the light amount Ls of the overlap region 380 does not exceed in the threshold value Lt in the intermediate section 213. When the virtual latent image 223 from which a toner image corresponding to the image data 501 is to be formed is formed, the controller 400 is only required to adjust the light amounts La of the first pulse lights 360-1 to 360-8 at the centers 361-1 to 361-8 and the light amounts Lb of the second pulse lights 370-1 to 370-8 at the centers 371-1 to 371-8, which are emitted from the exposure device 300, so that the light amount Ls of the overlap region 380 is equal to or more than the threshold value Lt in the intermediate section 213.

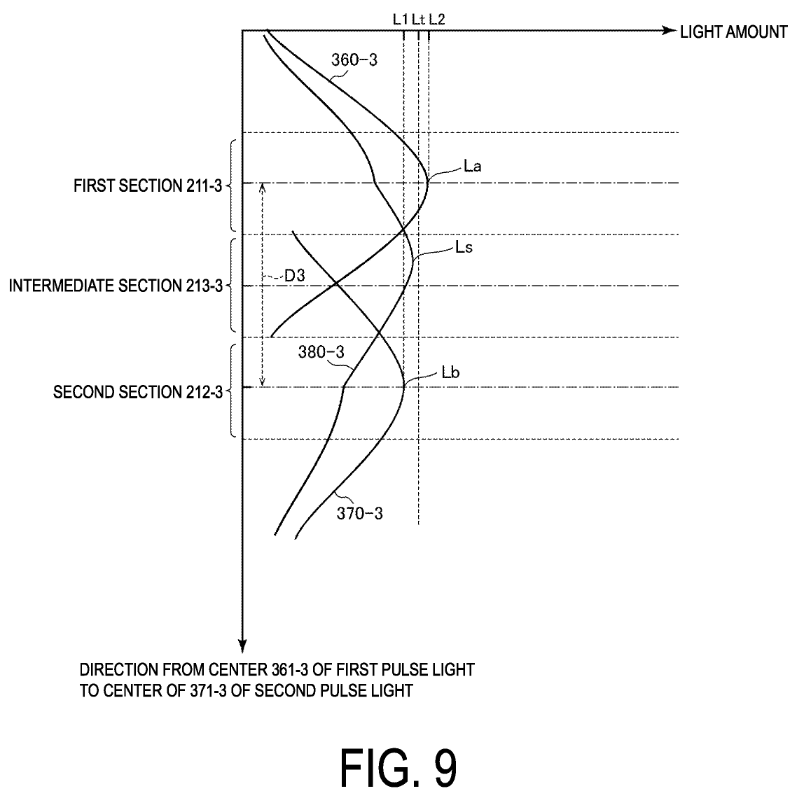

FIG. 9 is a diagram illustrating a light amount of the pulse light in the first section 211-3, the intermediate section 213-3, and the second section 212-3 of the third column in FIG. 5. The horizontal axis represents light amounts of the first pulse light 360-3 and the second pulse light 370-3, and a light amount in the overlap region 380-3. The vertical axis represents a position on the peripheral surface 201 in a virtual straight line along a direction from the center 361-3 to the center 371-3 in FIG. 5.

As illustrated in FIG. 4, the first pixel 511-3 corresponding to the first section 211-3 is filled, and the third pixel 513-3 corresponding to the second section 212-3 and the second pixel 512-3 corresponding to the intermediate section 213-3 are not filled. Accordingly, as illustrated in FIG. 6, the electrostatic latent image 220 from which a toner image corresponding to the image data 501 is to be formed is not formed for the virtual latent image 223-3. Thus, as illustrated in FIG. 5, the controller 400 controls the exposure device 300 so that the position of the center 361-3 and the position of the center 371-3 differ from each other in the first direction. Thus, the distance D3 between the center 361-3 and the center 371-3 is more than the minimum distance.

As illustrated in FIG. 9, in order to form the electrostatic latent image 220 from which a toner image corresponding to the image data 501 is to be formed for the first latent image 221-3, the light amount La of the first pulse light 360-3 at the center 361-3 is set to a second light amount L2 equal to or more than the threshold value Lt. Further, in order to prevent formation of the electrostatic latent image 220 from which a toner image corresponding to the image data 501 is to be formed for the second latent image 222-3, the light amount Lb of the second pulse light 370-3 at the center 371-3 is set to the first light amount L1 equal to or less than the threshold value Lt. The distance D3 between the center 361-3 and the center 371-3 is a distance more than the minimum distance. Thus, a region where a part of the first pulse light 360-3 and a part of the second pulse light 370-3 overlap with each other is reduced. Therefore, the maximum light amount Ls in the overlap region 380-3 can be reduced to be kept below the threshold value Lt. Accordingly, formation of the electrostatic latent image 220 from which a toner image corresponding to the image data 501 is to be formed can be prevented for the virtual latent image 223-3.

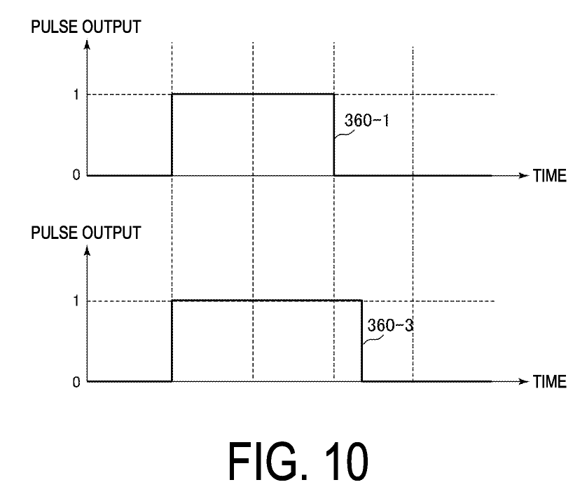

For example, the controller 400 controls the exposure device 300 by changing a pulse width of the pulse light. Accordingly, the light amount of the pulse light can be adjusted. When FIG. 7 and FIG. 9 are compared with each other, with respect to the common threshold value Lt, the light amount La of the first pulse light 360-1 at the center 361-1 is set to the first light amount L1 less than the threshold value Lt, and the light amount La of the first pulse light 360-3 at the center 361-3 is set to the second light amount L2 equal to or more than the threshold value Lt. Therefore, the light amount La of the first pulse light 360-3 at the center 361-3 is more than the light amount La of the first pulse light 360-1 at the center 361-1. FIG. 10 is a diagram illustrating a pulse waveform of the first pulse light 360-1 in the first column and a pulse waveform of the first pulse light 360-3 in the third column in the first section 211 of FIG. 5. As illustrated in FIG. 10, the pulse width of the pulse waveform of the first pulse light 360-3 is larger than the pulse width of the pulse waveform of the first pulse light 360-1. With this, an irradiation time of the first pulse light 360-3 is longer than that of the first pulse light 360-1. Accordingly, the light amount La of the first pulse light 360-3 at the center 361-3 can be increased more than the light amount La of the first pulse light 360-1 at the center 361-1.

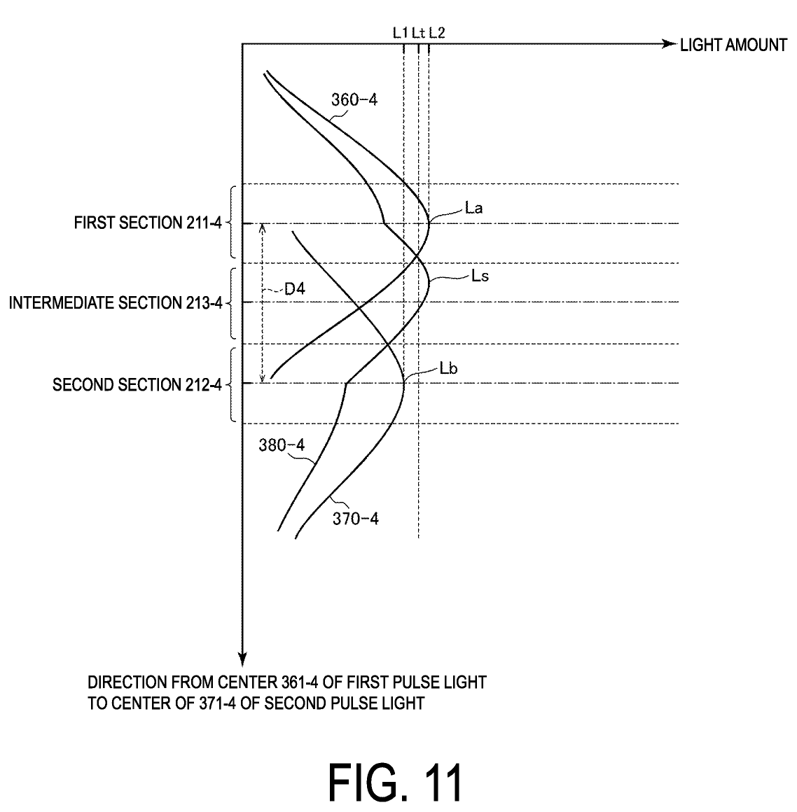

FIG. 11 is a diagram illustrating a light amount of the pulse light in the first section 211-4, the intermediate section 213-4, and the second section 212-4 of the fourth column in FIG. 5. The horizontal axis represents light amounts of the first pulse light 360-4 and the second pulse light 370-4, and a light amount in the overlap region 380-4. The vertical axis represents a position on the peripheral surface 201 in a virtual straight line along a direction from the center 361-4 to the center 371-4 in FIG. 5.

As illustrated in FIG. 4, the first pixel 511-4 corresponding to the first section 211-4 and the second pixel 512-4 corresponding to the intermediate section 213-4 are filled, and the third pixel 513-4 corresponding to the second section 212-4 is not filled. Accordingly, as illustrated in FIG. 6, the electrostatic latent image 220 is formed for the virtual latent image 223-4. Thus, as illustrated in FIG. 5, the controller 400 controls the exposure device 300 so that the position of the center 361-4 and the position of the center 371-4 coincide with each other in the first direction. Thus, the direction from the center 361-4 to the center 371-4 is the second direction, and the distance D4 between the center 361-4 and the center 371-4 is the minimum distance.

As illustrated in FIG. 11, in order to form the electrostatic latent image 220 from which a toner image corresponding to the image data 501 is to be formed for the first latent image 221-4, the light amount La of the first pulse light 360-4 at the center 361-4 is set to the second light amount L2 equal to or more than the threshold value Lt. Further, in order to prevent formation of the electrostatic latent image 220 from which a toner image corresponding to the image data 501 is to be formed for the second latent image 222-4, the light amount Lb of the second pulse light 370-4 at the center 371-4 is set to the first light amount L1 equal to or less than the threshold value Lt. The distance D4 is the minimum distance. Thus, a region where a part of the first pulse light 360-4 and a part of the second pulse light 370-4 overlap with each other is also maximized. Therefore, the maximum light amount Ls of the overlap region 380-4 can be equal to or more than the threshold value Lt, and the electrostatic latent image 220 from which a toner image corresponding to the image data 501 is to be formed can be formed for the virtual latent image 223-4.

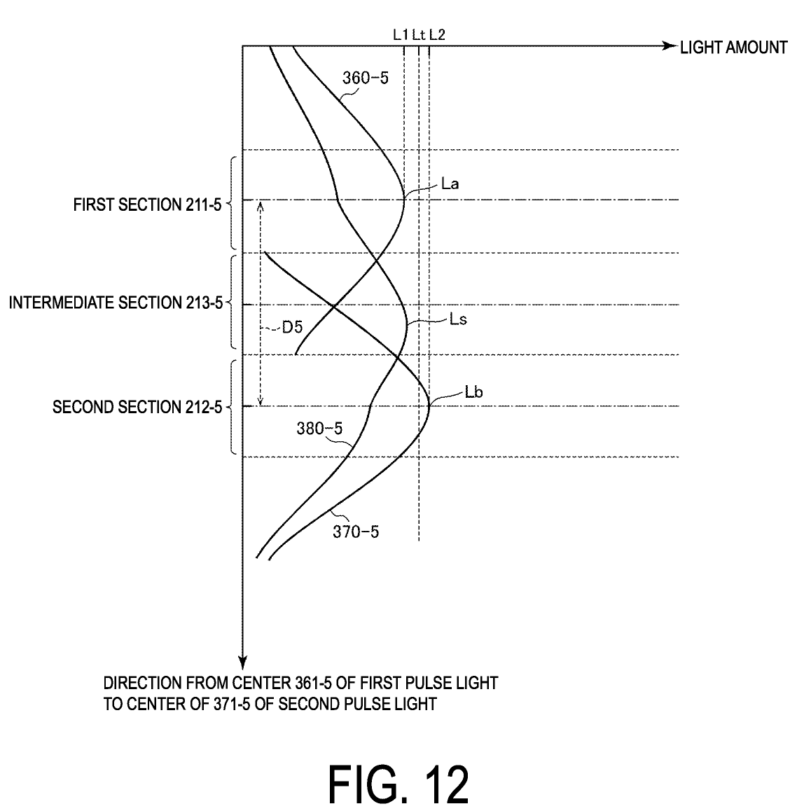

FIG. 12 is a diagram illustrating a light amount of the pulse light in the first section 211-5, the intermediate section 213-5, and the second section 212-5 of the fifth column in FIG. 5. The horizontal axis represents light amounts of the first pulse light 360-5 and the second pulse light 370-5, and a light amount in the overlap region 380-5. The vertical axis represents a position on the peripheral surface 201 in a virtual straight line along a direction from the center 361-5 to the center 371-5 in FIG. 5.

As illustrated in FIG. 4, the first pixel 511-5 corresponding to the first section 211-5 and the second pixel 512-5 corresponding to the intermediate section 213-5 are not filled, and the third pixel 513-5 corresponding to the second section 212-5 is filled. Accordingly, as illustrated in FIG. 6, the electrostatic latent image 220 from which a toner image corresponding to the image data 501 is to be formed is not formed for the virtual latent image 223-5. Thus, as illustrated in FIG. 5, the controller 400 controls the exposure device 300 so that the position of the center 361-5 and the position of the center 371-5 differ from each other in the first direction. Thus, the distance D5 between the center 361-5 and the center 371-5 is more than the minimum distance.

As illustrated in FIG. 12, in order to prevent formation of the electrostatic latent image 220 from which a toner image corresponding to the image data 501 is to be formed for the first latent image 221-5, the light amount La of the first pulse light 360-5 at the center 361-5 is set to the first light amount L1 less than the threshold value Lt. Further, in order to form the electrostatic latent image 220 from which a toner image corresponding to the image data 501 is to be formed for the second latent image 222-5, the light amount Lb of the second pulse light 370-5 at the center 371-5 is set to the second light amount L2 equal to or more than the threshold value Lt. The distance D5 is a distance more than the minimum distance. Thus, a region where the first pulse light 360-5 and a part of the second pulse light 370-5 overlap with each other is reduced. Therefore, the maximum light amount Ls in the overlap region 380-5 can be reduced to be kept below the threshold value Lt. Accordingly, formation of the electrostatic latent image 220 from which a toner image corresponding to the image data 501 is to be formed can be prevented for the virtual latent image 223-5.

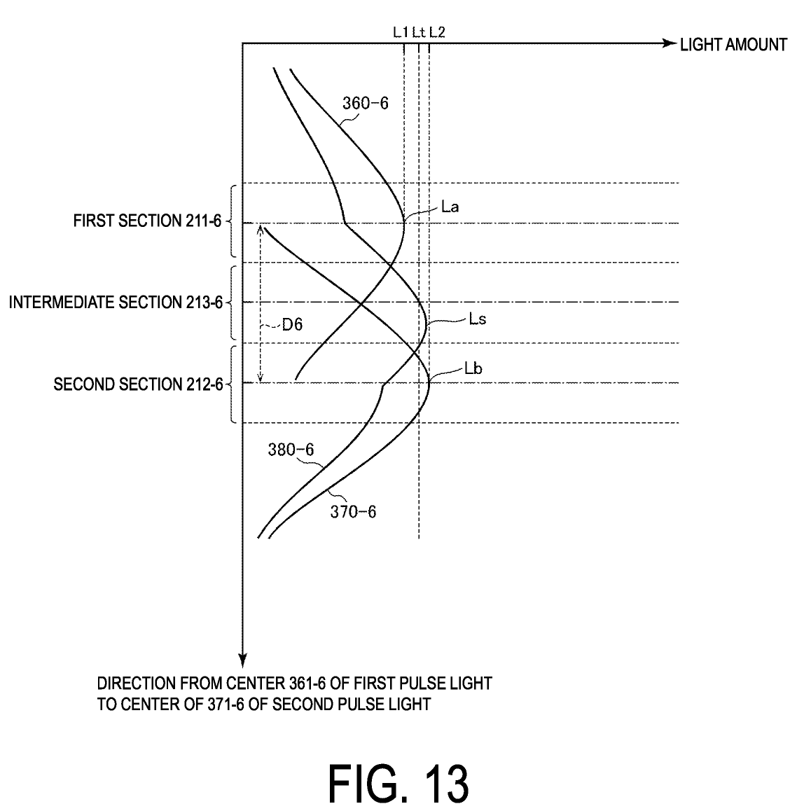

FIG. 13 is a diagram illustrating a light amount of the pulse light in the first section 211-6, the intermediate section 213-6, and the second section 212-6 of the sixth column in FIG. 5. The horizontal axis represents light amounts of the first pulse light 360-6 and the second pulse light 370-6, and a light amount in the overlap region 380-6. The vertical axis represents a position on the peripheral surface 201 in a virtual straight line along a direction from the center 361-6 to the center 371-6 in FIG. 5.

As illustrated in FIG. 4, the first pixel 511-6 corresponding to the first section 211-6 is not filled, and the second pixel 512-6 corresponding to the intermediate section 213-6 and the third pixel 513-6 corresponding to the second section 212-6 are filled. Accordingly, as illustrated in FIG. 6, the electrostatic latent image 220 from which a toner image corresponding to the image data 501 is to be formed is formed for the virtual latent image 223-6. Thus, as illustrated in FIG. 5, the controller 400 controls the exposure device 300 so that the position of the center 361-6 and the position of the center 371-6 coincide with each other in the first direction. Thus, the direction from the center 361-6 to the center 371-6 is the second direction, and the distance D6 between the center 361-6 and the center 371-6 is the minimum distance.

As illustrated in FIG. 13, in order to prevent formation of the electrostatic latent image 220 from which a toner image corresponding to the image data 501 is to be formed for the first latent image 221-6, the light amount La of the first pulse light 360-6 at the center 361-6 is set to the first light amount L1 less than the threshold value Lt. Further, in order to form the electrostatic latent image 220 from which a toner image corresponding to the image data 501 is to be formed for the second latent image 222-6, the light amount Lb of the second pulse light 370-6 at the center 371-6 is set to the second light amount L2 equal to or more than the threshold value Lt. The distance D6 is the minimum distance. Thus, a region where a part of the first pulse light 360-6 and a part of the second pulse light 370-6 overlap with each other is also maximized. Therefore, the maximum light amount Ls of the overlap region 380-6 can be equal to or more than the threshold value Lt, and the electrostatic latent image 220 from which a toner image corresponding to the image data 501 is to be formed can be formed for the virtual latent image 223-6.

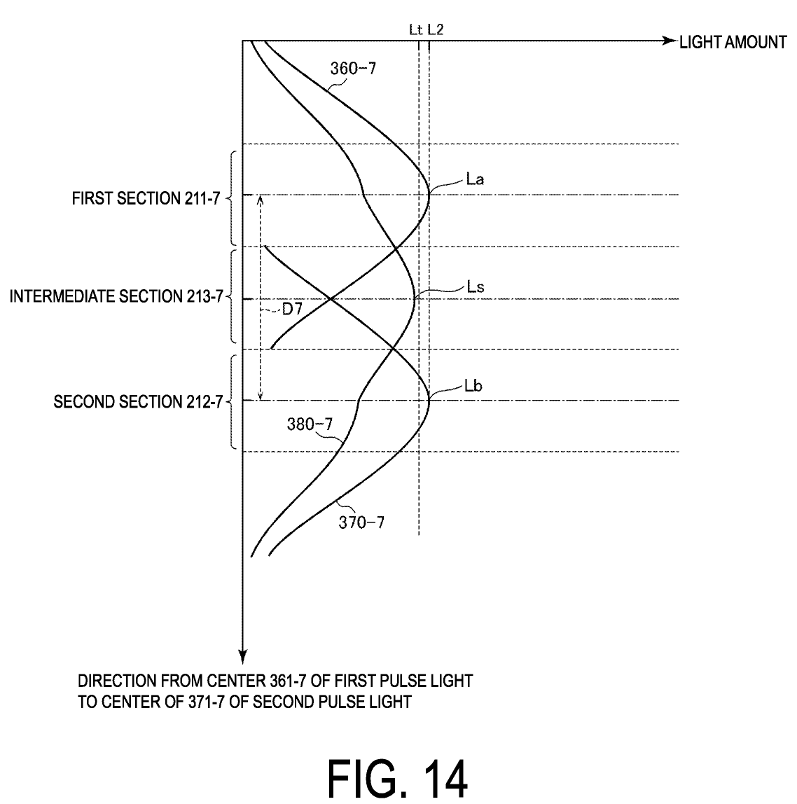

FIG. 14 is a diagram illustrating a light amount of the pulse light in the first section 211-7, the intermediate section 213-7, and the second section 212-7 of the seventh column in FIG. 5. The horizontal axis represents light amounts of the first pulse light 360-7 and the second pulse light 370-7, and a light amount in the overlap region 380-7. The vertical axis represents a position on the peripheral surface 201 in a virtual straight line along a direction from the center 361-7 to the center 371-7 in FIG. 5.

As illustrated in FIG. 4, the first pixel 511-7 corresponding to the first section 211-7 and the third pixel 513-7 corresponding to the second section 212-7 are filled, and the second pixel 512-7 corresponding to the intermediate section 213-7 is not filled. Accordingly, as illustrated in FIG. 6, the electrostatic latent image 220 is not formed for the virtual latent image 223-7. Thus, as illustrated in FIG. 5, the controller 400 controls the exposure device 300 so that the position of the center 361-7 and the position of the center 371-7 differ from each other in the first direction. Thus, the distance D7 between the center 361-7 and the center 371-7 is more than the minimum distance.

As illustrated in FIG. 14, in order to form the electrostatic latent image 220 from which a toner image corresponding to the image data 501 is to be formed for the first latent image 221-7 and the second latent image 222-7, both the light amount La of the first pulse light 360-7 at the center 361-7 and the light amount Lb of the second pulse light 370-7 at the center 371-7 are set to the second light amount L2 equal to or more than the threshold value Lt. The distance D7 is a distance more than the minimum distance. Thus, a region where the first pulse light 360-7 and a part of the second pulse light 370-7 overlap with each other is reduced. Therefore, the maximum light amount Ls in the overlap region 380-7 can be reduced to be kept below the threshold value Lt. Accordingly, formation of the electrostatic latent image 220 from which a toner image corresponding to the image data 501 is to be formed can be prevented for the virtual latent image 223-7.

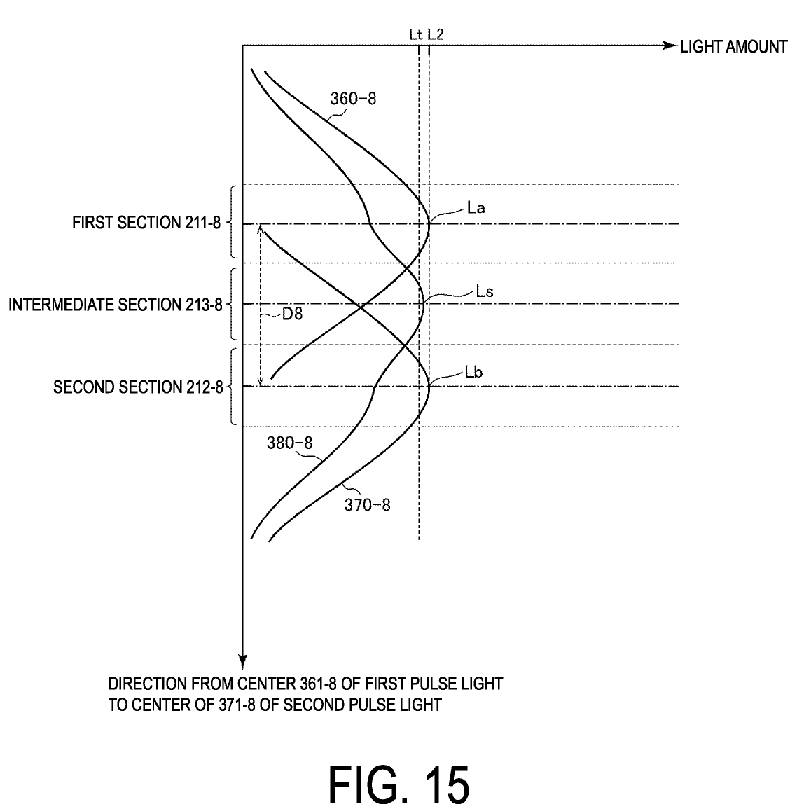

FIG. 15 is a diagram illustrating a light amount of the pulse light in the first section 211-8, the intermediate section 213-8, and the second section 212-8 of the eighth column in FIG. 5. The horizontal axis represents light amounts of the first pulse light 360-8 and the second pulse light 370-8, and a light amount in the overlap region 380-8. The vertical axis represents a position on the peripheral surface 201 in a virtual straight line along a direction from the center 361-8 to the center 371-8 in FIG. 5.

As illustrated in FIG. 4, all of the first pixel 511-8 corresponding to the first section 211-8, the second pixel 512-8 corresponding to the intermediate section 213-8, and the third pixel 513-8 corresponding to the second section 212-8 are filled. Accordingly, as illustrated in FIG. 6, the electrostatic latent image 220 from which a toner image corresponding to the image data 501 is to be formed is formed for the virtual latent image 223-8. Thus, as illustrated in FIG. 5, the controller 400 controls the exposure device 300 so that the position of the center 361-8 and the position of the center 371-8 coincide with each other in the first direction. Thus, the direction from the center 361-8 to the center 371-8 is the second direction, and the distance D8 between the center 361-8 and the center 371-8 is the minimum distance.

As illustrated in FIG. 15, in order to form the electrostatic latent image 220 from which a toner image corresponding to the image data 501 is to be formed for the first latent image 221-7 and the second latent image 222-7, both the light amount La of the first pulse light 360-7 at the center 361-7 and the light amount Lb of the second pulse light 370-7 at the center 371-7 are set to the second light amount L2 equal to or more than the threshold value Lt. The distance D8 is the minimum distance. Thus, a region where a part of the first pulse light 360-8 and a part of the second pulse light 370-8 overlap with each other is also maximized. Therefore, the maximum light amount Ls of the overlap region 380-8 can be equal to or more than the threshold value Lt, and the electrostatic latent image 220 from which a toner image corresponding to the image data 501 is to be formed can be formed for the virtual latent image 223-8.

### Modification Example

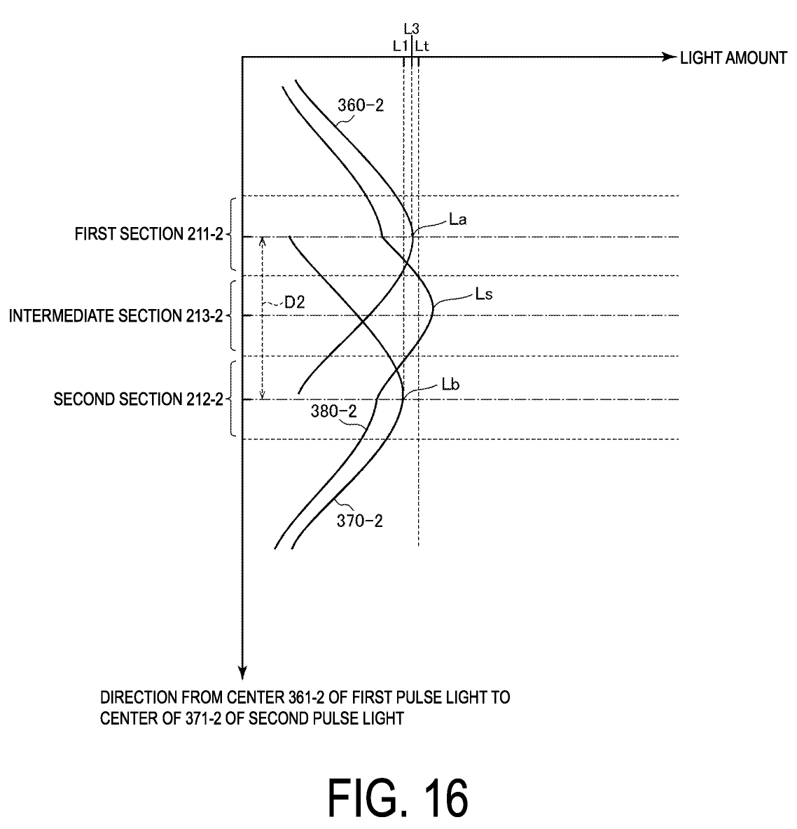

The modification example of the present disclosure is described below with reference to FIG. 16 to FIG. 19. In the following description, the matters that are common in the respective drawings the description given above are omitted as appropriate. In the modification example of the present disclosure, in a case in which the virtual latent image 223 from which a toner image corresponding to the image data 501 is to be formed is not formed, the controller 400 sets the light amount La of the first pulse light to the first light amount L1 when the first latent image 221 from which a toner image corresponding to the image data 501 is to be formed is not formed, and sets the light amount of the first pulse light to the second light amount L2 when the first latent image from which a toner image corresponding to the image data 501 is to be formed is formed. Further, in a case in which the virtual latent image 223 from which a toner image corresponding to the image data 501 is to be formed is formed, the controller 400 sets the light amount La of the first pulse light to a third light amount L3 when the first latent image 221 from which a toner image corresponding to the image data 501 is to be formed is not formed, and sets the light amount of the first pulse light to a fourth light amount L4 when the first latent image from which a toner image corresponding to the image data 501 is to be formed is formed. Further, the controller 400 controls the exposure device 300 so that the intensity of the light amount of the pulse light satisfies a relationship of the first light amount L1 < the third light amount L3 < the second light amount L2 < the fourth light amount L4.

FIG. 16 is a diagram illustrating a light amount of the pulse light in the first section 211-2, the intermediate section 213-2, and the second section 212-2 in the second column in FIG. 5 in the modification example. When FIG. 8 and FIG. 16 are compared with each other, the modification example differs in that the light amount La of the first pulse light 360-2 at the center 361-2 is changed to the third light amount L3, thereby changing the light amount in the overlap region 380-2, and the other matters are common to those in FIG. 8.

As illustrated in FIG. 16, the light amount La of the first pulse light 360-2 at the center 361-2 is set to the third light amount L3 more than the first light amount L1. Further, as illustrated in FIG. 6, the electrostatic latent image 220 from which a toner image corresponding to the image data 501 is to be formed is not formed for the first latent image 221-2, and hence the third light amount L3 is less than the threshold value Lt. As illustrated in FIG. 16, in the modification example, the light amount La of the first pulse light 360-2 at the center 361-2 is increased to the third light amount L3. Accordingly, the maximum light amount Ls of the overlap region 380-2 is also increased. Accordingly, as compared to the case in FIG. 8, the maximum light amount Ls in the overlap region 380-2 can be equal to or more than the threshold value Lt more securely, and the electrostatic latent image 220 from which a toner image corresponding to the image data 501 is to be formed can be formed more securely for the virtual latent image 223-2.

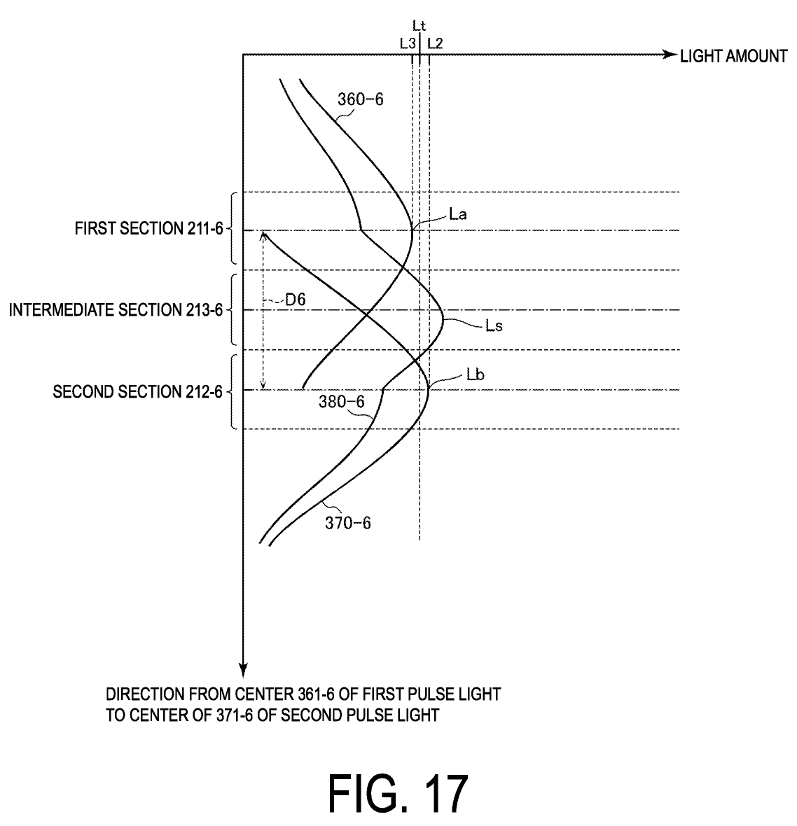

FIG. 17 is a diagram illustrating a light amount of the pulse light in the first section 211-6, the intermediate section 213-6, and the second section 212-6 in the sixth column in FIG. 5 in the modification example. When FIGS. 13 and 17 are compared with each other, the modification example differs in that the light amount La of the first pulse light 360-6 at the center 361-6 is changed to the third light amount L3, thereby changing the light amount in the overlap region 380-6, and the other matters are common to those in FIG. 13.

As illustrated in FIG. 17, the light amount La of the first pulse light 360-6 at the center 361-6 is set to the third light amount L3 more than the first light amount L1. Further, as illustrated in FIG. 6, the electrostatic latent image 220 from which a toner image corresponding to the image data 501 is to be formed is not formed for the first latent image 221-6, and hence the third light amount L3 is less than the threshold value Lt. As illustrated in FIG. 17, in the modification example, the light amount La of the first pulse light 360-6 at the center 361-6 is increased to the third light amount L3. Accordingly, the maximum light amount Ls of the overlap region 380-6 is also increased. Accordingly, as compared to the case in FIG. 13, the maximum light amount Ls in the overlap region 380-6 can be equal to or more than the threshold value Lt more securely, and the electrostatic latent image 220 from which a toner image corresponding to the image data 501 is to be formed can be formed more securely for the virtual latent image 223-6.

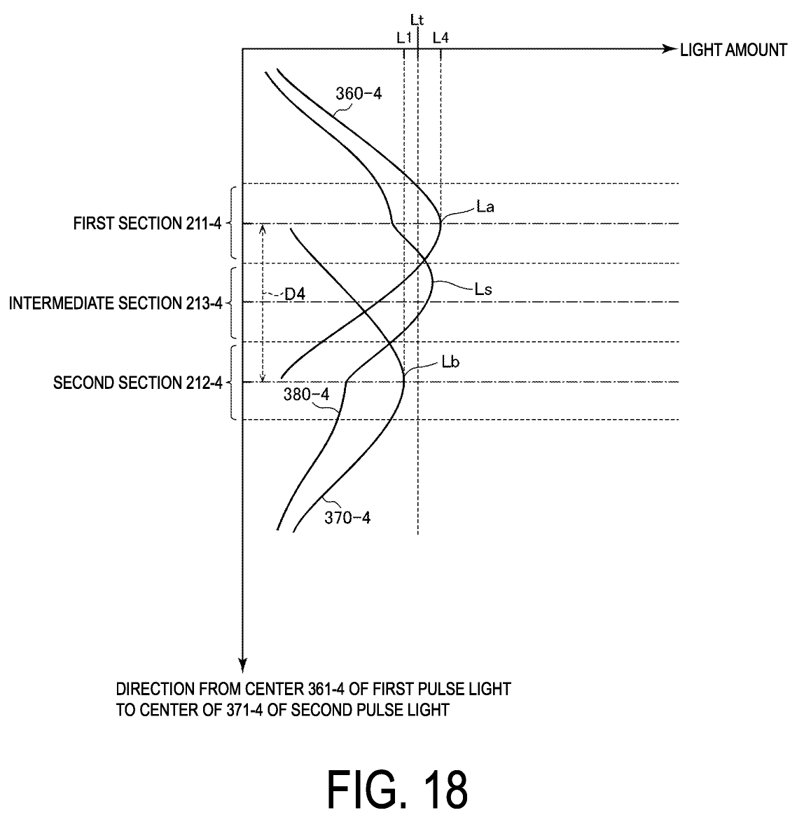

FIG. 18 is a diagram illustrating a light amount of the pulse light in the first section 211-4, the intermediate section 213-4, and the second section 212-4 in the fourth column in FIG. 5 in the modification example. When FIGS. 11 and 18 are compared with each other, the modification example differs in that the light amount La of the first pulse light 360-4 at the center 361-4 is changed to the fourth light amount L4, thereby changing the light amount in the overlap region 380-4, and the other matters are common to those in FIG. 11.

As illustrated in FIG. 18, the light amount La of the first pulse light 360-4 at the center 361-4 is set to the fourth light amount L4 more than the second light amount L2. As illustrated in FIG. 18, in the modification example, the light amount La of the first pulse light 360-4 at the center 361-4 is increased to the fourth light amount L4. Accordingly, the maximum light amount Ls of the overlap region 380-2 is also increased. Accordingly, as compared to the case in FIG. 11, the maximum light amount Ls in the overlap region 380-4 can be equal to or more than the threshold value Lt more securely, and the electrostatic latent image 220 from which a toner image corresponding to the image data 501 is to be formed can be formed more securely for the virtual latent image 223-4.

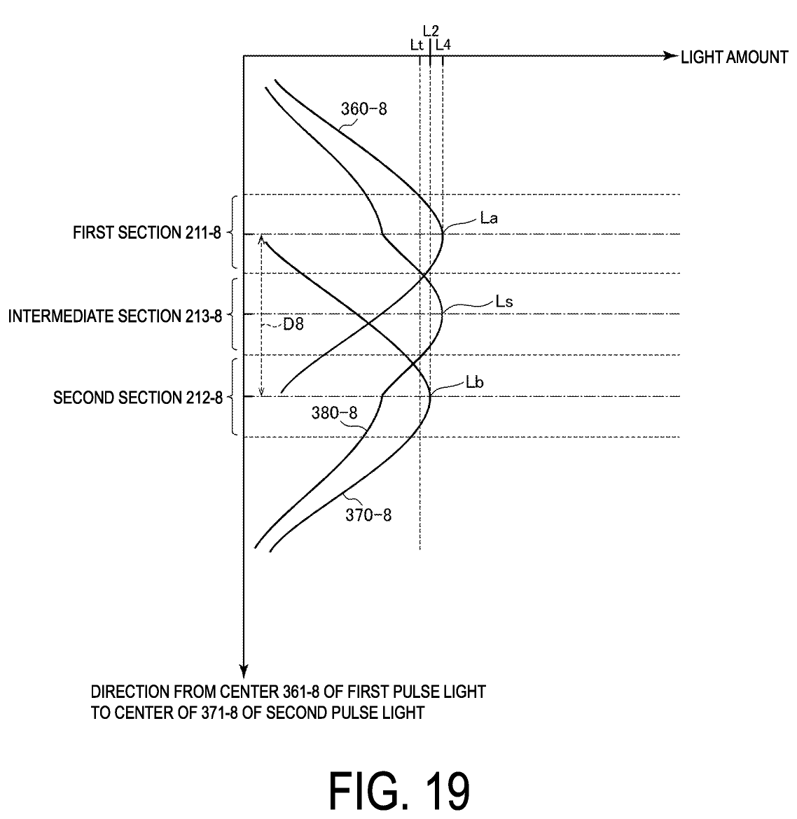

FIG. 19 is a diagram illustrating a light amount of the pulse light in the first section 211-8, the intermediate section 213-8, and the second section 212-8 in the eighth column in FIG. 5 in the modification example. When FIGS. 15 and 19 are compared with each other, the modification example differs in that the light amount La of the first pulse light 360-8 at the center 361-8 is changed to the fourth light amount L4, thereby changing the light amount in the overlap region 380-4, and the other matters are common to those in FIG. 15.

As illustrated in FIG. 19, the light amount La of the first pulse light 360-8 at the center 361-8 is set to the fourth light amount L4 more than the second light amount L2. As illustrated in FIG. 19, in the modification example, the light amount La of the first pulse light 360-8 at the center 361-8 is increased to the fourth light amount L4. Accordingly, the maximum light amount Ls of the overlap region 380-8 is also increased. Accordingly, as compared to the case in FIG. 15, the maximum light amount Ls in the overlap region 380-8 can be equal to or more than the threshold value Lt more securely, and the electrostatic latent image 220 from which a toner image corresponding to the image data 501 is to be formed can be formed more securely for the virtual latent image 223-8.

Note that the present disclosure is not limited to the configurations of the above-mentioned embodiment and modifications, and may be replaced with configurations that are substantially the same as, configurations that achieve the same effects as, or configurations that can achieve the same objects as the configurations shown in the above-mentioned embodiment and modifications.

1. An image forming apparatus, comprising:
a photoreceptor;
an exposure device that forms an electrostatic latent image on the photoreceptor by irradiating, with pulse light, a plurality of sections arrayed in a first direction and a second direction orthogonal to the first direction; and
a controller that controls the exposure device, wherein
the controller controls the exposure device to emit the pulse light so that in a first section and a second section arrayed along the second direction among the plurality of sections, positions of centers of the pulse light in the first direction are selected to coincide with or differ from each other.

2. The image forming apparatus according to claim 1, further comprising:
an image processor that transmits a control signal based on image data formed by a plurality of pixels to the controller, wherein
the electrostatic latent image is an image obtained by arraying a first latent image, a virtual latent image, and a second latent image in the second direction,
the exposure device forms the first latent image by using first pulse light with which the first section is irradiated, forms the second latent image by using second pulse light with which the second section is irradiated, and forms the virtual latent image in an intermediate section between the first section and the second section by using an overlap region where a part of the first pulse light and a part of the second pulse light overlap with each other, and
the controller controls, based on the control signal, the exposure device to form the electrostatic latent image by causing three consecutive pixels among the plurality of pixels to respectively correspond to the first section, the intermediate section, and the second section.

3. The image forming apparatus according to claim 1, wherein
a plurality of the first sections are arrayed in the first direction, and
a plurality of the second sections are arrayed in the first direction.

4. The image forming apparatus according to claim 2, wherein
the controller controls the exposure device so that a position of a center of the first pulse light and a position of a center of the second pulse light differ from each other in the first direction when the virtual latent image is not formed, and controls the exposure device so that the position of the center of the first pulse light and the position of the center of the second pulse light coincide with each other in the first direction when the virtual latent image is formed.

5. The image forming apparatus according to claim 4, wherein
the controller controls the exposure device to adjust a light amount of the pulse light by changing a pulse width of the pulse light.

6. The image forming apparatus according to claim 5, further comprising:
a development device that supplies toner to the photoreceptor and develops a toner image corresponding to the image data, wherein
when a light amount of the pulse light is equal to or more than a predetermined threshold value, the electrostatic latent image from which the toner image is to be developed is formed on the photoreceptor, and
the controller controls the exposure device to adjust a light amount of the first pulse light and a light amount of the second pulse light so that a light amount in the overlap region is less than the threshold value in the intermediate section when the virtual latent image from which the toner image is to be developed is not formed on the photoreceptor, and controls the exposure device to adjust a light amount of the first pulse light and a light amount of the second pulse light so that a light amount in the overlap region is equal to or more than the threshold value in the intermediate section when the virtual latent image from which the toner image is to be developed is formed on the photoreceptor.

7. The image forming apparatus according to claim 6, wherein
in a case where the virtual latent image from which the toner image is to be developed is not formed on the photoreceptor, the controller further controls the exposure device to set a light amount of the first pulse light to a first light amount when the first latent image from which the toner image is to be developed is not formed on the photoreceptor and to set a light amount of the first pulse light to a second light amount when the first latent image from which the toner image is to be developed is formed on the photoreceptor,
in a case where the virtual latent image from which the toner image is to be developed is formed on the photoreceptor, the controller further controls the exposure device to set a light amount of the first pulse light to a third light amount when the first latent image from which the toner image is to be developed is not formed on the photoreceptor and to set a light amount of the first pulse light to a fourth light amount when the first latent image from which the toner image is to be developed is formed on the photoreceptor, and
the controller further controls the exposure device so that the intensity of the light amount satisfies the first light amount < the third light amount < the second light amount < the fourth light amount.

8. The image forming apparatus according to claim 2, wherein
the image processor generates position information, in which the position of the center of the first pulse light and the position of the center of the second pulse light are decided in the first direction so that the first latent image, the virtual latent image, and the second latent image are formed based on the image data, and transmits the position information to the controller, and
the controller controls the exposure device, based on the position information.

9. The image forming apparatus according to claim 8, wherein
the image processor generates the position information by deciding the position of the center of the second pulse light in the first direction with reference to the position of the center of the first pulse light in the first direction.
